(19) United States
(12) Patent Application Publication
(10) Pub. No.: US 2009/0037381 A1
(43) Pub. Date: Feb. 5, 2009

(54) Data registration and retrieval method, data registration and retrieval program and database system

(75) Inventors: Sansei Oshima, Higashimurayama (JP); Norihiro Hara, Kawasaki (JP); Takeo Maruyama, Yokohama (JP); Masashi Tsuchida, Machida (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Ltd., Tokyo (JP)

(21) Appl. No.: 12/075,056

(22) Filed: Mar. 7, 2008

(30) Foreign Application Priority Data
Jul. 31, 2007 (JP) 2007-200116

(51) Int. Cl. G06F 17/30

(52) U.S. Cl. 707/3; 707/E17.014

(57) ABSTRACT

A database system registers data unreflected in an index into a registration text buffer. When the database system retrieves a registration text buffer, the database system prepares a registration buffer index using retrieval character indicated by a retrieval request. Thereafter, when a retrieval request is received, an index in a database is retrieved. When there is no pertinent data in the index, the registration buffer index is retrieved. An index indicated by the registration buffer index is used to retrieve the registration text buffer. The database system reflects the registration buffer index in the index at predetermined timing. Thus, even if the number of data registered in the registration text buffer is increased, the retrieval time is not increased.

### INCORPORATION BY REFERENCE

The present application claims priority from Japanese application JP2007-200116 filed on Jul. 31, 2007, the content of which is hereby incorporated by reference into this application.

### BACKGROUND OF THE INVENTION

The present invention relates to data registration and retrieval technique of a database.

Recently, there is the technique that in order to perform full-text search in a database at high speed, an index for full-text search is prepared in a database system and the index (e.g. n-gram index) is used to perform full-text search. The method of using the index for full-text search is excellent in retrieval performance but has a problem that it takes time to prepare and register the index. Further, in another technique, in order to solve such a problem, data is stored in a registration text buffer when the data is to be registered in a database newly. When retrieval of the database is performed, the index for full-text search is first referred to and data which is not reflected in the index is retrieved from the registration text buffer. That is, the database system stores data in the buffer upon registration of the data and the data is not reflected in the index for full-text search immediately to thereby reduce the registration time in the database (refer to JP-A-10-240754).

### SUMMARY OF THE INVENTION

In the prior art described above, however, when the number of data registered in the registration text buffer is increased, the registration time is increased in proportion to the increased number of data. Accordingly, it is an object of the present invention to solve the above problem and prevent the increase of the retrieval time of a database.

In order to solve the above problem, the database system according to the present invention prepares a registration buffer index for retrieval for data unreflected in index in a registration text buffer to prevent increase of the retrieval time of data. The database system first stores data unreflected in the index into the registration buffer. Further, the database system refers to the index upon retrieval of data. When there is no index for data to be retrieved, the database system refers to the registration buffer index. The database system retrieves the data stored in the registration buffer. At this time, the database system prepares an index for a retrieval request at the timing that the registration buffer is retrieved and stores it in the registration buffer index. The index is the 1-gram index system, for example. The database system deletes the data having prepared index in the registration buffer.

According to the present invention, even when the data unreflected in the index is increased in the registration text buffer of the database, increase of the retrieval time can be prevented.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram illustrating the whole configuration of a database system according to an embodiment of the present invention;

FIG. 2 is a diagram illustrating a registration text buffer used in the database system of FIG. 1;

FIG. 3 is a diagram illustrating a registration buffer index used in the database system of FIG. 1;

FIG. 4 is a diagram illustrating the outline of operation of the database system of FIG. 1;

FIG. 5 is a flow chart showing detailed retrieval processing of XML data shown in FIG. 4;

FIG. 6 is a diagram illustrating an concrete example of processing of steps S403, S404, S411 and S412 of FIG. 5;

FIG. 7 is a flow chart showing a processing procedure of a registration buffer index retrieval unit used in the database system of FIG. 1;

FIG. 8 is a flow chart showing a processing procedure of a registration buffer index management unit used in the database system of FIG. 1; and

FIG. 9 is a flow chart showing a processing procedure of a registration text buffer deletion unit used in the database system of FIG. 1.

### DESCRIPTION OF THE EMBODIMENTS

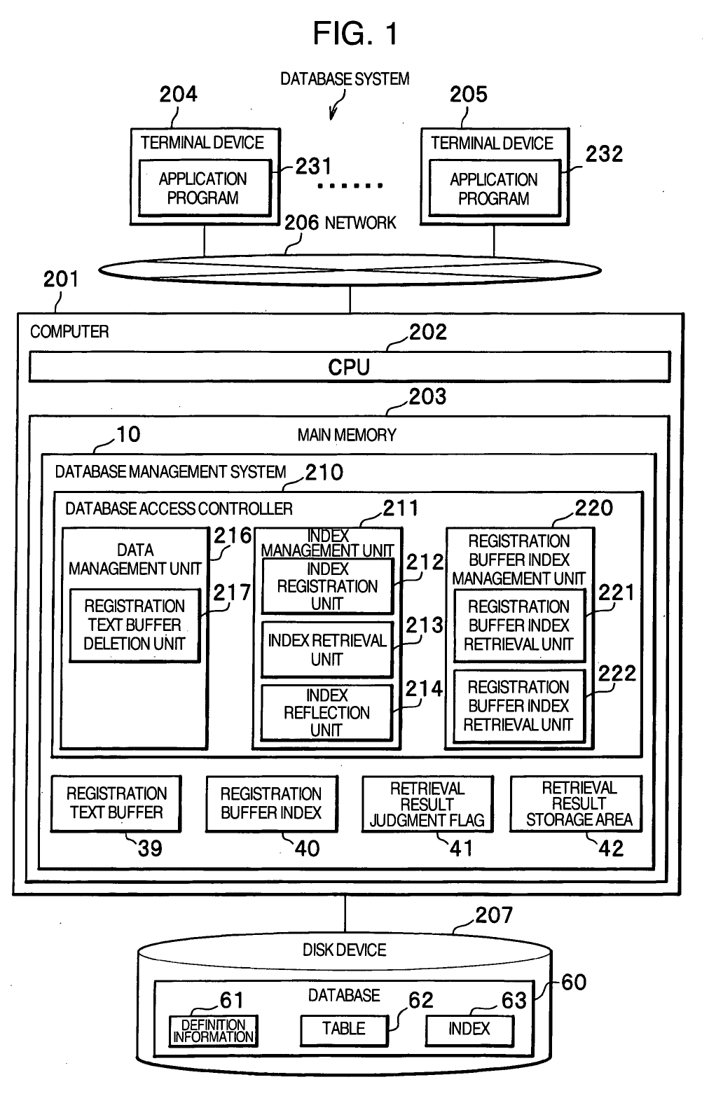

An embodiment of the present invention is now described with reference to the accompanying drawings. Referring first to FIG. 1, a database system according to an embodiment of the present invention is described. FIG. 1 is a schematic diagram illustrating the whole configuration of the database system according to the embodiment. In the following description, XML (Extensible Markup Language) data is used as data stored in a database by way of example, although other data except this may be used.

The database system of the embodiment includes a computer 201 connected to a network 206, terminal devices 204 and 205 and a disk apparatus 207 connected to the computer 201. The terminal devices 204, 205 are realized by personal computers (PC), for example, and are connected to input device (keyboard, mouse and the like) and output device (liquid crystal display and the like) not shown. The network 206 is realized by the Internet, local area network (LAN) or the like, for example. The number of the terminal devices, the computer 201 and the disk apparatus 207 is not limited to that shown in FIG. 1.

The computer 201 includes a central processing unit (CPU) 202 and a main memory 203 composed of a random access memory (RAM). Although not shown, the computer 201 includes a network interface for transmitting and receiving data through the network 206 and an input/output interface for inputting and outputting data between the computer 201 and the input device and the output device connected to the computer 201.

Moreover, the main memory 203 includes a database management system 10, a registration text buffer 39 and a registration buffer index 40. The main memory 203 has an area for storing retrieval result judgment flag 41 and a retrieval result record area 42. In FIG. 1, the database management system 10 is shown in the state that it is loaded into the main memory 203 as a program. The database management system 10, the registration text buffer (registration buffer) 39, the registration buffer index 40, the retrieval result judgment flag 41 and the retrieval result record area 42 are described in detail later.

The terminal devices 204 and 205 include application programs 231 and 232, respectively. The application programs 231, 232 function to transmit a retrieval request to the database management system and to receive a result of the retrieval request from the database management system 10.

The disk apparatus 207 includes a database 60. The disk apparatus 207 is realized by a storage apparatus such as, for example, a hard disk drive (HDD) and a flash memory. The disk apparatus 207 may be provided in the computer 201.

The database 60 contains definition information 61, table 62 for storing XML data and index 63 for XML data.

The definition information 61 is information indicating identification information of the index 63 for XML data stored in each table 62 of the database 60. The definition information 61 illustrated below indicates that the index for “T1” of the table 62 is “Idx1”. A database access controller 210 refers to the definition information 61, so that the database access controller 210 can understand whether the index 63 is prepared in the table 62 or not.

TABLE 1
DEFINITION INFORMATION 61

| Table | Index |
|---|---|
| T1 | Idx1 |
| . . . | . . . |

The table 62 stores the XML data. In the table 62, XML data is stored in a corresponding manner to each data number (data identifier) of the XML data. The table 62 is illustrated in the following table 2. XML data for the data numbers “1” and “2” are stored in “TI” of the table 62.

TABLE 2
TI (TABLE 62)

| Data Number | XML Data |
|---|---|
| 1 | XML Data |
| 2 | XML Data |

XML data unreflected in the index 63 is also stored in the table 62. Moreover, metadata (e.g. registration date of XML data) concerning the XML data may be also contained in the table 62 in addition to the XML data.

The index 63 is the index for the XML data stored in the table 62. The index 63 is prepared for each table 62. The index 63 is retrieved by an index retrieval unit 213 (described later).

The index 63 contains a character string index for retrieving a character string of XML data, for example. The character string index is an index indicating a data number of XML data containing a character string and a character position in the XML data in each character string (retrieval characters). The index retrieval unit 213 can retrieve the index 63 to get XML data containing a character string indicated by retrieval conditions and a character position of the character string in the XML data. The index 63 is the n-gram index, for example.

The database management system 10 includes the database access controller 210 for controlling access to the database 60.

The database access controller 210 includes a data management unit 216, an index management unit 211 and a registration buffer index management unit 220. The database access controller 210 calls up the data management unit 216, the index management unit 211 and the registration buffer index management unit 220 in response to a retrieval request and a data registration request transmitted from the application programs 231, 232 and returns a result of the request to the application programs 231, 232.

The data management unit 216 performs taking out, update and deletion of data in the database 60 stored in the disk apparatus 207. The data management unit 216 includes a registration text buffer deletion unit 217. The registration text buffer deletion unit 217 deletes data having prepared index in the registration buffer index 40 from the registration text buffer 39.

The index management unit 211 performs retrieval and registration of the index 63. The index management unit 211 includes an index registration unit 212, an index retrieval unit 213 and an index restore unit 214.

The index registration unit 212 performs processing of registering XML data in the database 60 of the disk apparatus 207 in response to a request from the application programs 231, 232. The index retrieval unit 213 retrieves XML data of the disk apparatus 207 using the index 63 in response to a retrieval request transmitted from the application program 231, 232. The index restore unit 214 reflects the registration buffer index 40 in the index 63.

The registration buffer index management unit 220 performs registration and retrieval of the registration buffer index 40. The registration buffer index management unit 220 includes a registration buffer index registration unit 221 and a registration buffer index retrieval unit 222. The registration buffer index management unit 220 starts these units in response to a retrieval request from the application programs 231, 232.

The registration buffer index registration unit 221 prepares the registration buffer index 40 for retrieving data to be retrieved from the registration text buffer 39 upon retrieval of the registration text buffer 39.

The registration buffer index retrieval unit 222 retrieves the registration buffer index 40 upon retrieval of the registration text buffer 39.

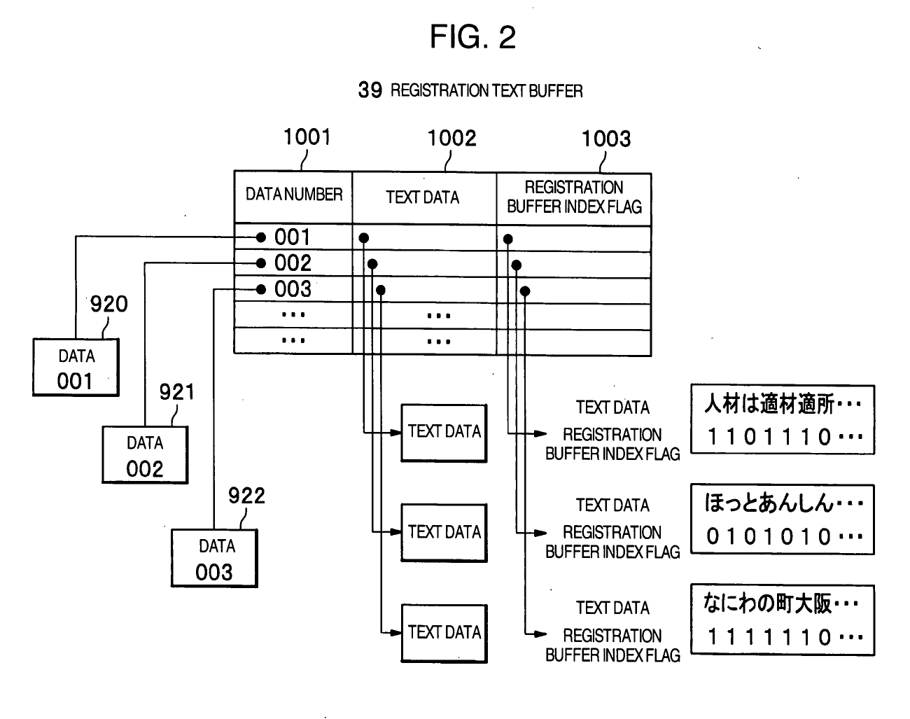

The registration text buffer 39 stores data unreflected in the database 60. That is, when the data management unit 216 receives XML data registered in the database 60, the data management unit 216 first stores the data in the registration text buffer 39. An example of the registration text buffer 39 is shown in FIG. 2.

FIG. 2 illustrates the registration text buffer of FIG. 1. As shown in FIG. 2, the registration text buffer 39 is information indicating data identifiers (data numbers) 1001 of text data, text data 1002 and registration buffer index flags 1003. In the registration buffer index flag 1003, flag value “1” is given to retrieved parts (characters) in the text data 1002. Data 001 (data of data number “001”) indicated by reference numeral 920, data 002 (data of data number “002”) indicated by reference numeral 921, data 003 (data of data number “003”) indicated by reference numeral 922 and the registration buffer index flags of the respective data are stored in the registration text buffer 39 shown in FIG. 2. For example, the data 001 in the registration text buffer 39 of FIG. 2 has [symbol] (Japanese character meaning person)”, [symbol] (Japanese character meaning man)”, [symbol] (Japanese character meaning right)”, [symbol] and [symbol] given “1” indicating that these characters have been retrieved by the registration buffer index retrieval unit 222.

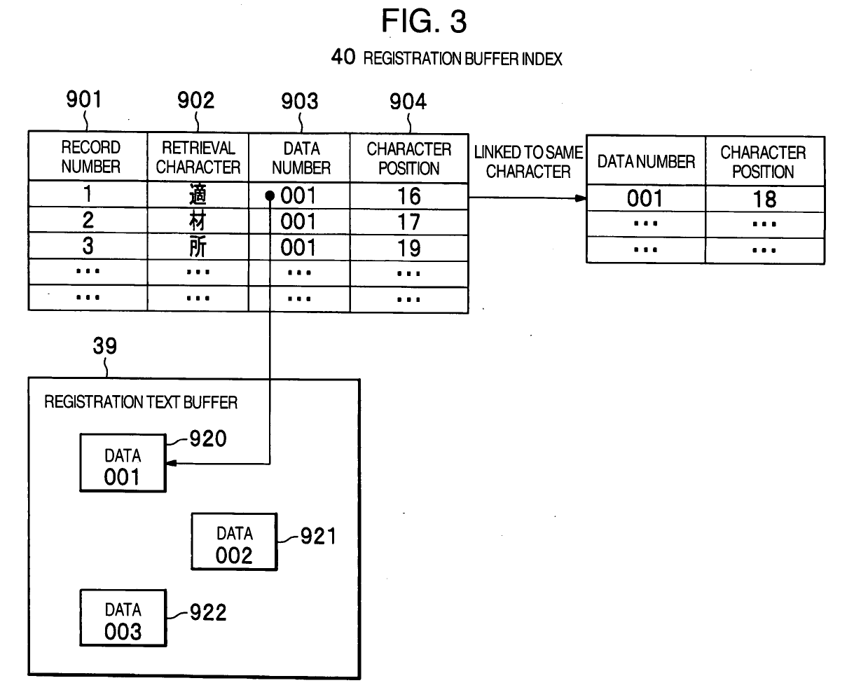

The registration buffer index 40 of FIG. 1 is an index for performing retrieval for the registration text buffer 39 and as described above the registration buffer index registration unit 221 prepares the registration buffer index 40 upon retrieval of the registration text buffer 39. The registration buffer index 40 is information indicating the data number of data containing the retrieval characters and the character position in the data in each of retrieval characters (characters to be retrieved). The registration buffer index 40 is described with reference to FIG. 3.

FIG. 3 illustrates the registration buffer index of FIG. 1. As shown in FIG. 3, the registration buffer index 40 is an index for data 001 indicated by reference numeral 920, data 002 indicated by reference numeral 921 and data 003 indicated by reference numeral 922 and includes record number 901 of serial number for each record, retrieval character 902, data number 903 of data containing the retrieval character and character position 904 in the data. When there are a plurality of indexes for the same character (e.g. [symbol] ), the record therefor may be linked as shown in FIG. 3. For example, the index having the record number “1” in the registration buffer index 40 shown in FIG. 3 indicates that the retrieval character [symbol] exists at character positions “16” and “18” of data designated by the data number “001”. By preparing such a registration buffer index 40, the database management system 10 can retrieve data in the registration text buffer 39 efficiently.

The retrieval result judgment flag 41 of FIG. 1 is information indicating, when the database management system 10 receives a retrieval request, a retrieval result (as to whether data satisfying retrieval conditions thereof can be detected or not) of the index 63, the registration buffer index 40 and the registration text buffer 39 responsive to the retrieval request as a flag value.

The retrieval result record area 42 is an area for storing the retrieval result of the index 63, the registration buffer index 40 and the registration text buffer 39. The retrieval result includes information indicating the data number of data satisfying the retrieval conditions and an area in the data (character position) in addition to the judgment result as to whether the data satisfying the retrieval conditions can be detected or not.

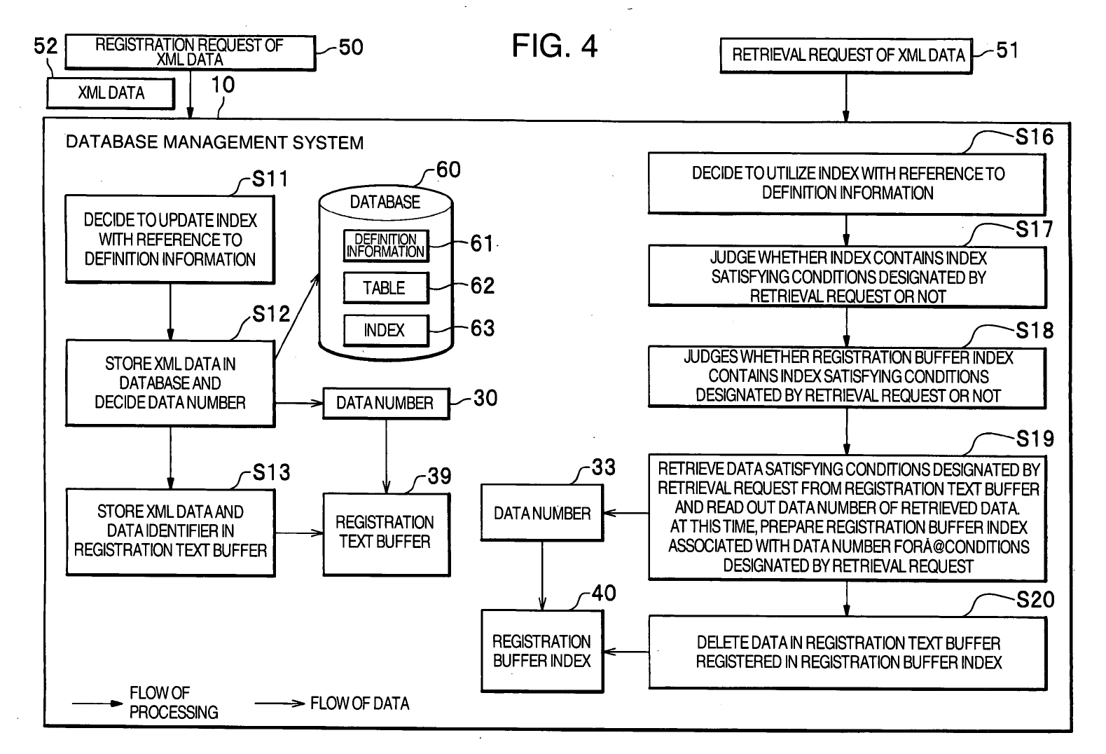

Referring now to FIG. 4, the outline of operation of the database system shown in FIG. 1 is described. FIG. 4 is a diagram illustrating the outline of operation of the database system of FIG. 1. The database system performs two processing operations containing registration processing of XML data and retrieval processing of XML data, broadly divided. In this example, description is made to the case where the application program 231 of the terminal device 204 transmits a registration request of data and the application program 232 of the terminal device 205 transmits a retrieval request of data.

First, the database management system 10 receives input containing XML data 52 and a registration request 50 of the XML data 52 from the application program 231 of the terminal device 204. The registration request contains identification information (e.g. “T1”) of the table 62 which is a registration destination of the XML data 52.

The data management unit 216 of FIG. 1 decides to update the index 63 with reference to the definition information 61 of the database 60 (step S11). For example, when the table 62 of the registration destination of the XML data is “T1”, the data management unit 216 judges whether “T1” of the table 62 contains the XML data or not with reference to the definition information 61. When the XML data is not contained in the table 62, the data management unit 216 decides to update the index 63. On the other hand, when the XML data is already contained in the index 63, the data management unit 216 does not update the index 63.

Next, the data management unit 216 stores the XML data 52 in the database 60 and decides the data number (see reference numeral 30) of the XML data 52 (step S12). For example, the XML data 52 is stored in the table “T1” of the database 60 and the data number “001” of the XML data 52 is decided.

Then, the index registration unit 212 associates the inputted XML data 52 with the data number decided in step S12 to be stored in the registration text buffer 39 (step S13).

As described above, the data management unit 216 stores the XML data unregistered in the index 63 into the registration text buffer 39.

Next, the retrieval processing of the XML data illustrated in the right half of FIG. 4 is described. In this example, description is made to the case where the database management system 10 first retrieves the index 63 and then retrieves the registration buffer index 40, although the database management system 10 may first retrieve the registration buffer index 40 and then retrieve the index 63.

The database management system 10 receives input containing a retrieval request 51 of XML data from the application program 232 of the terminal device 205.

Next, the index retrieval unit 213 of the index management unit 211 decides to utilize the index 63 with reference to the definition information 61 of the database 60 (step S16). That is, the index retrieval unit 213 reads out the index 63 of the database 60 with reference to the definition information 61.

The index retrieval unit 213 judges whether the index 63 contains an index (index concerning characters indicated by the retrieval request 51) satisfying the conditions designated by the retrieval request or not (step S17). The index retrieval unit 213 transmits the judgment result to the application program 232 of the terminal device 205. That is, when the index 63 contains the index satisfying the conditions designated by the retrieval request 51, data retrieved from the database 60 using the index is transmitted to the application program 232 of the terminal unit 205. On the other hand, when the index 63 does not contain the index satisfying the conditions designated by the retrieval request 51, the processing proceeds to step S18.

Next, the registration buffer index retrieval unit 222 judges whether the registration buffer index 40 contains the index satisfying the conditions designated by the retrieval request 51 or not (step S18). The registration buffer index retrieval unit 222 transmits the retrieval result to the application program 232 of the terminal device 205. That is, when the registration buffer index 40 contains the index satisfying the conditions designated by the retrieval request as the result of the retrieval of the index satisfying the conditions designated by the retrieval request 51, data retrieved from the registration text buffer 39 using the index is transmitted to the application program 232 of the terminal device 205. On the other hand, when the data satisfying the conditions designated by the retrieval request 51 cannot be detected, the processing proceeds to step S19.

The registration buffer index retrieval unit 222 retrieves the data satisfying the conditions designated by the retrieval request 51 from the registration text buffer 39 and reads out the data number (see reference numeral 33) of the retrieved data. At this time, the registration buffer index registration unit 221 prepares the registration buffer index 40 associated with the read-out data number for the conditions designated by the retrieval request 51 (step S19).

The registration buffer index 40 is the 1-gram index system, for example. The 1-gram index system is described later. Next, the registration text buffer deletion unit 217 deletes data in the registration text buffer 39 registered in the registration buffer index 40 (step S20). That is, the registration text buffer deletion unit 217 deletes the data having the prepared registration buffer index 40 for all parts of the data among the data in the registration text buffer 39 from the registration text buffer 39.

Generally, the 1-gram index system is the system where which place of which document each character appears at for connected 1 character (1-gram) is registered as an index. In the embodiment, in order to simplify the index preparation processing, the registration buffer index 40 is the 1-gram index system by way of example, although 2-gram or more index system may be adopted.

As described above, the database access controller 210 prepares the index for data (e.g. retrieval character) retrieved once from the registration text buffer 39 and registers it in the registration buffer index 40. Accordingly, for example, when the database access controller 210 receives a retrieval request for the same retrieval character again, it is not necessary to scan (retrieve) the registration text buffer 39 and accordingly retrieval can be made efficiently.

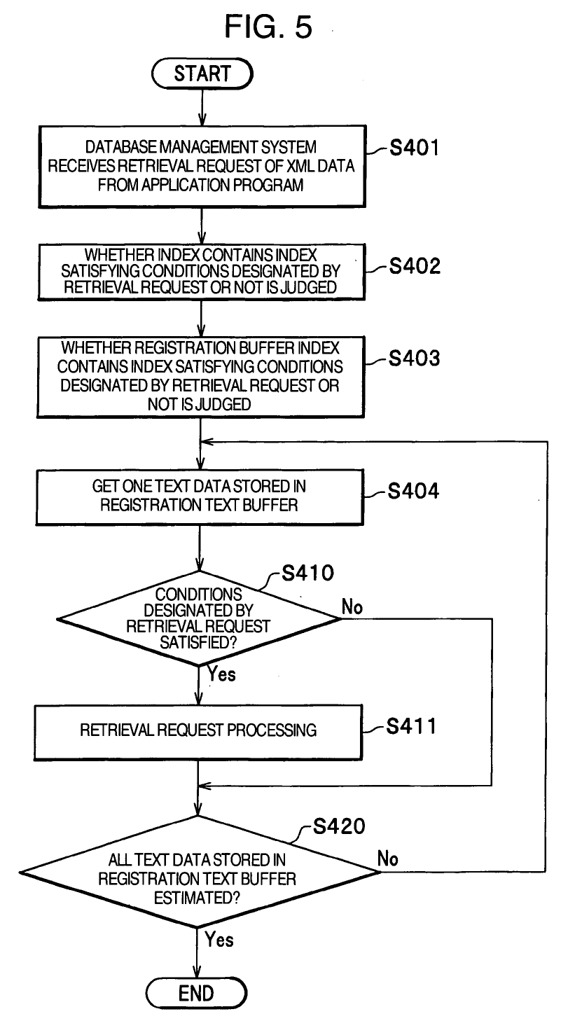

Referring now to FIG. 5, the retrieval processing of XML data in FIG. 4 is described in detail. FIG. 5 is a flow chart showing detailed retrieval processing of XML data in FIG. 4.

First, the database access controller 210 of the database management system 10 receives input of the retrieval request 51 of the XML data from the application program 231 (step S401).

The index retrieval unit 213 judges whether the index 63 contains the index satisfying the conditions designated by the retrieval request 51 or not (step S402).

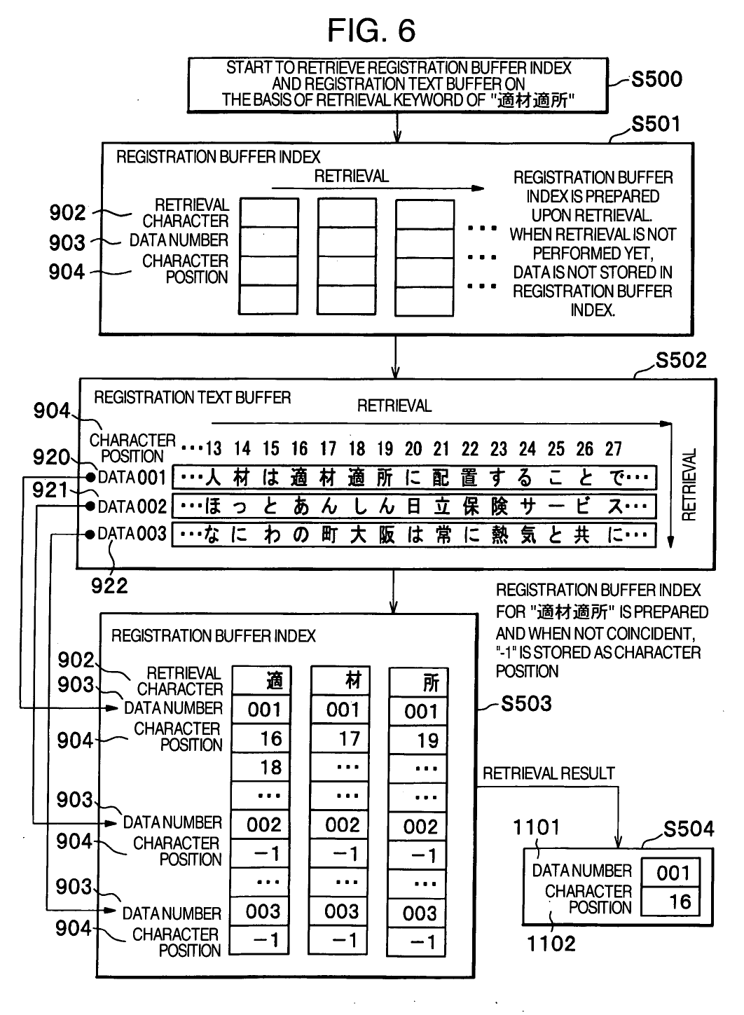

Next, the registration buffer index retrieval unit 222 judges whether the registration buffer index 40 contains the index satisfying the conditions designated by the retrieval request 51 or not (step S403). The processing of the registration buffer index retrieval unit 222 is described in detail with reference to FIG. 6.

The registration buffer index registration unit 221 gets one text data stored in the registration text buffer 39 (step S404).

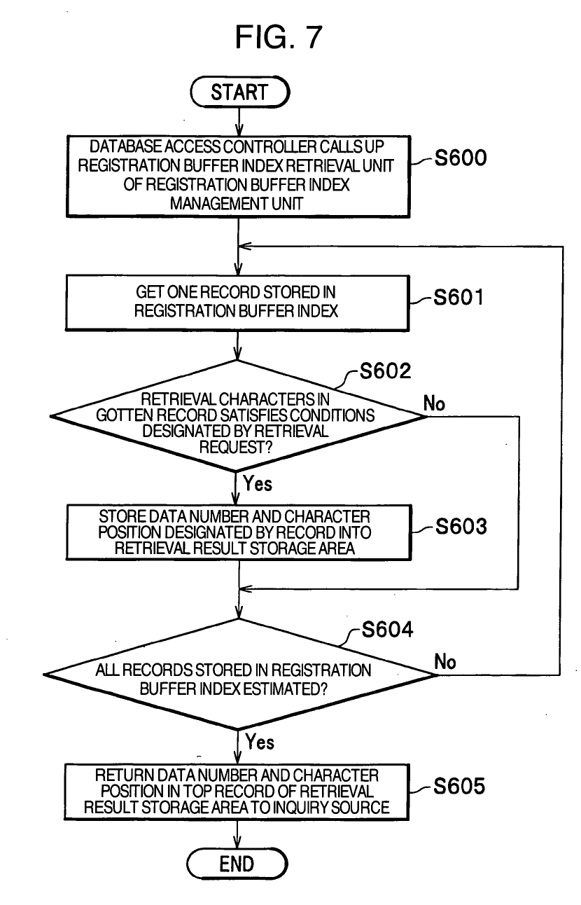

The registration buffer index registration unit 221 judges whether the text data gotten in step S404 satisfies the conditions designated by the retrieval request or not (step S410). When the text data gotten in step S404 satisfies the conditions designated by the retrieval request (“Yes” of step S410), the retrieval request processing is performed (step S411). The processing in step S411 is described later. On the other hand, when the text data gotten in step S404 does not satisfy the conditions designated by the retrieval request (“No” of step 410), the processing proceeds to step S420. The processing in step S420 is described later. Further, the processing of the registration buffer index registration unit 221 is described in detail later with reference to FIG. 7.

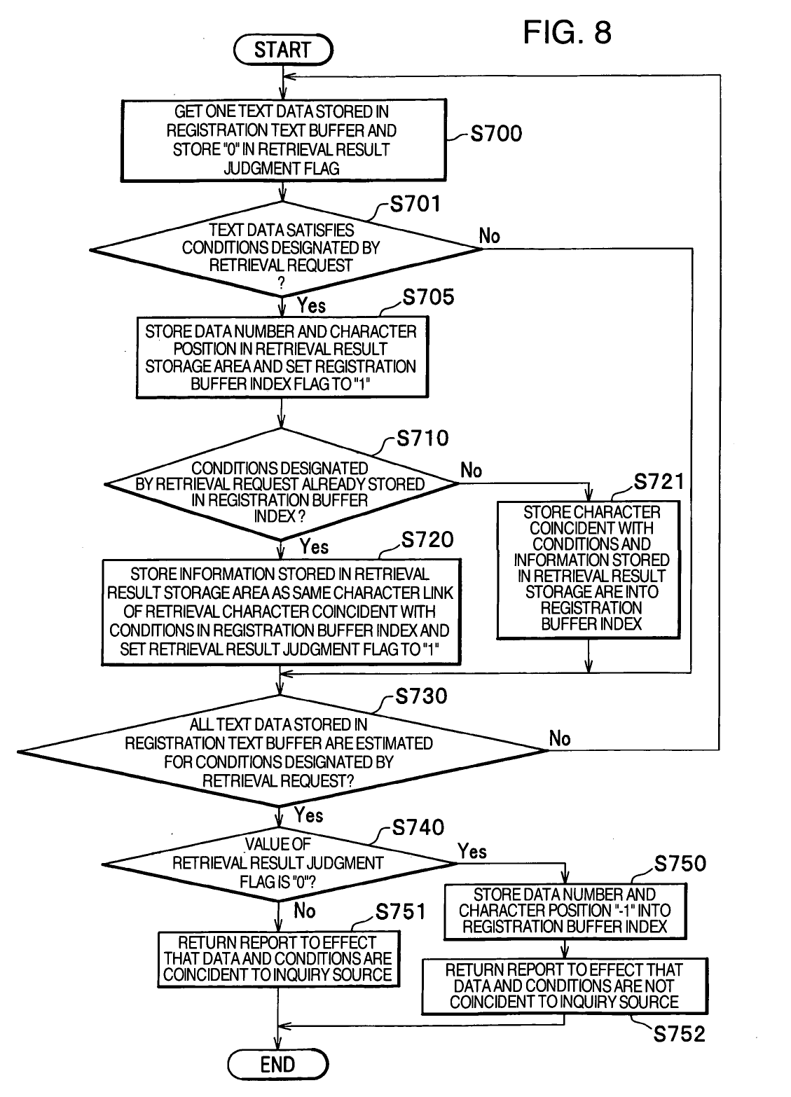

In the retrieval request processing in step S411, the following processing operations (1) and (2) are performed in parallel. That is, (1) the registration buffer index retrieval unit 222 gets data satisfying the conditions designated by the retrieval request 51 from the registration text buffer 39 and transmits the data to an inquiry source of the data (e.g. the application program 232 of the terminal device 205). (2) The registration buffer index registration unit 221 prepares the registration buffer index 40 associated with the conditions designated by the retrieval request 51 for the data satisfying the conditions designated by the retrieval request 51 of the registration text buffer 39. When registration of the registration buffer index 40 for all data in the registration text buffer 39 is completed, the registration text buffer deletion unit 217 deletes the data in the registration text buffer 39. Then, the processing proceeds to step S420. The processing of the registration text buffer deletion unit 217 is described in detail later with reference to FIG. 8.

After such processing, the registration buffer index registration unit 221 judges whether all the text data stored in the registration text buffer 39 has been estimated or not (step S420) and when the estimation of all the text data is completed (“Yes” of step S420), the processing is ended. On the other hand, when the registration text buffer 39 contains any text data not estimated (“No” of step S420), the processing is returned to step S404.

As described above, the database access controller 210 prepares the registration buffer index 40 for the data (e.g. character string) gotten by once retrieving the registration text buffer 39.

Although description is omitted, when the text data gotten in step S404 does not satisfy the conditions designated by the retrieval request, information to that effect may be written in the registration buffer index 40. For example, “−1” may be written as information of the character position concerning the character indicated by the retrieval request of the registration buffer index 40.

The processing in steps S403, 404, 411 and 412 of FIG. 5 is described concretely with reference to FIG. 6. FIG. 6 illustrates a concrete example of the processing in steps S403, 404, 411 and 412 of FIG. 5.

In this example, description is made to the case where a data number of data containing [symbol] (Japanese characters meaning the right man in the right place)” and a character position thereof are retrieved on the basis of a retrieval request containing retrieval keyword of [symbol] It is supposed that the retrieval keyword of [symbol] is not used in the retrieval processing performed so far. Further, it is supposed that three data having the data numbers “001” to “003” are stored in the registration text buffer 39 and data is not registered in the registration buffer index 40 in the initial state.

A concrete example of the processing in step S403 of FIG. 5 is first described. The registration buffer index management unit 220 starts to perform retrieval of the registration buffer index 40 and the registration text buffer 39 on the basis of the retrieval keyword of [symbol] (step S500). First, the registration buffer index retrieval unit 222 retrieves the registration buffer index 40 on the basis of the retrieval keyword of [symbol] In this case, since the registration buffer index management unit 220 prepares the registration buffer index for the 1-gram index, the registration buffer index 40 coincident with each character of [symbol] and [symbol] (Japanese character meaning place)” is retrieved.

Further, the registration buffer index registration unit 221 prepares the registration buffer index 40 upon retrieval of the registration text buffer 39 (that is, after retrieval is made once). Data is not stored in the registration buffer index 40 in the state (initial state) that retrieval of the registration text buffer 39 is not performed yet. Accordingly, even when the registration buffer index retrieval unit 222 retrieves the registration buffer index 40 in step S501, data containing the retrieval character cannot be detected.

Next, a concrete example of the processing in step S404 of FIG. 5 is described. The registration buffer index registration unit 221 retrieves the registration text buffer 39 (step S502). For example, the registration buffer index registration unit 221 first judges whether data having the data number “001” indicated by reference numeral 920 contains the character string coincident with the retrieval keyword of [symbol] or not. As a result, the registration buffer index registration unit 221 detects that characters at the character positions “16, 17, 18 and 19” of the data having the data number “001” are coincident with the retrieval keyword.

Then, the registration buffer index registration unit 221 also judges whether data having the data number “002” indicated by reference numeral 921 contains the characters coincident with the retrieval keyword of [symbol] or not. As a result, there is no character string coincident with the retrieval keyword.

Moreover, the registration buffer index registration unit 221 also judges whether data having the data number “003” indicated by reference numeral 922 contains the characters coincident with the retrieval keyword of [symbol] or not. As a result, there is no character string coincident with the retrieval keyword.

In this manner, the registration buffer index registration unit 221 performs judgment as to whether there are characters coincident with the retrieval keyword or not for all the data stored in the registration text buffer 39.

Next, an concrete example of the processing in step S412 of FIG. 5 is described. The registration buffer index registration unit 221 prepares the registration buffer index 40 for the retrieval keyword of [symbol] (step S503). First, the registration buffer index registration unit 221 prepares the registration buffer index 40 for the data having the data number “001” indicated by reference numeral 920. Since the data having the data number “001” is coincident with the retrieval keyword at the character positions “16, 17, 18 and 19”, the registration buffer index registration unit 221 stores a character of [symbol] into the retrieval character 902 of the registration buffer index 40 and further stores the data number “001” of the data and the character position “16” of the character into the column thereof. Moreover, since the character of [symbol] also appears at the character position “18”, the registration buffer index registration unit 221 also stores “18” as the character position into the same column.

Then, the registration buffer index registration unit 221 stores a character of [symbol] into the retrieval character 902 of the registration buffer index 40 and further stores the data number “001” and the character position “17” into the column thereof. Next, the registration buffer index registration unit 221 stores a character of [symbol] into the retrieval character 902 of the registration buffer index 40 and further stores the data number “001” and the character position “19” into the column thereof.

As described above, the registration buffer index registration unit 221 prepares the registration buffer index 40 for the data number “001”.

Next, the registration buffer index registration unit 221 prepares the registration buffer index 40 for the data having the data number “002” indicated by reference numeral 921. Since the data having the data number “002” is not coincident with the retrieval keyword (refer to step S502), the registration buffer index registration unit 221 stores the data number “002” and the character position “−1” in the column in which [symbol] of the retrieval character 902 in the registration buffer index 40 is stored.

Next, the registration buffer index registration unit 221 prepares the registration buffer index 40 for the data having the data number “003” indicated by reference numeral 922. Since the data having the data number “003” is not coincident with the retrieval keyword (refer to step S502), the registration buffer index registration unit 221 stores the data number “003” and the character position “−1” in the column in which [symbol] of the retrieval character 902 in the registration buffer index 40 is stored. Furthermore, the registration buffer index registration unit 221 also stores the data number “003” and the character position “−1” in the column in which [symbol] and [symbol] of the retrieval characters 902 are stored.

As described above, the registration buffer index registration unit 221 prepares the registration buffer index for the data having the data numbers “002” and “003” stored in the registration text buffer 39.

Next, description is made to the processing of making the registration buffer index retrieval unit 222 get data satisfying the conditions designated by the retrieval request 51 from the registration text buffer 39 and transmit the data to the inquiry source of the data in the retrieval request processing in step S411 of FIG. 5. For example, the registration buffer index registration unit 221 returns the retrieval result for the retrieval keyword of [symbol] to the inquiry source (e.g. the application program 232 of the terminal device 205) (step S504). In this example, since only the data having the data number “001” is coincident with the retrieval keyword, “001” as the data number 1101 and “16” as the character position (start position of the character string of the retrieval keyword) are returned to the inquiry source as the retrieval result.

Referring now to FIG. 7, a processing procedure of the registration buffer index retrieval unit 222 of FIG. 1 is described. FIG. 7 is a flow chart showing a processing procedure of the registration buffer index retrieval unit of FIG. 1.

First, the database access controller 210 calls up the registration buffer index retrieval unit 222 of the registration buffer index management unit 220 (step S600). The called-up registration buffer index retrieval unit 222 gets one record stored in the registration buffer index 40 (refer to FIG. 3) (step S601).

The registration buffer index retrieval unit 222 judges whether the retrieval character in the record gotten in step S601 satisfies the conditions designated by the retrieval request or not (step S602). For example, the registration buffer index retrieval unit 222 judges whether the record contains the retrieval keyword designated by the retrieval request or not.

When the retrieval character in the record gotten in step S601 satisfies the conditions designated by the retrieval request (“Yes” of step S602), the registration buffer index retrieval unit 222 stores the data number and the character position indicated by the record into the retrieval result record area (step S603).

The registration buffer index retrieval unit 222 judges whether all the records stored in the registration buffer index 40 are estimated or not (S604). When all the records are estimated for the conditions designated by the retrieval request (“Yes” of step S604), the data number and the character position in the top record of the retrieval result record area are returned to the inquiry source (step S605) and the processing is ended. That is, the registration buffer index retrieval unit 222 returns the data number of the data containing the retrieval keyword and the start position of the retrieval keyword to the inquiry source.

On the other hand, in step S602, when the retrieval characters in the record gotten in step S601 do not satisfy the conditions designated by the retrieval request (“No” of step S602), the processing proceeds to step S604. Moreover, when the registration buffer index retrieval unit 222 does not complete the estimation for all the records stored in the registration buffer index 40 (“No” of step S604), the processing is returned to step S601.

As described above, the registration buffer index retrieval unit 222 reads out the data number of the data containing the retrieval keyword indicated by the retrieval request and the start position of the retrieval keyword using the registration buffer index 40.

Referring next to FIG. 8, the procedure that the registration buffer index management unit 220 of FIG. 1 retrieves the registration text buffer 39 is described. FIG. 8 is a flow chart showing the retrieval procedure of the registration text buffer 39 of FIG. 1.

The registration buffer index registration unit 221 of the registration buffer index management unit 220 gets one text data (data) stored in the registration text buffer 39. “0 (initial value)” is stored in the retrieval result judgment flag of the text data (step S700).

The registration buffer index registration unit 221 judges whether the text data gotten in step S700 satisfies the conditions designated by the retrieval request or not (step S701). That is, the registration buffer index registration unit 221 judges whether the text data contains the retrieval keyword designated by the retrieval request or not one by one. When the text data satisfies the conditions designated by the retrieval request (“Yes” of step S701), the registration buffer index registration unit 221 stores the data number of the text data and the character position of the retrieval keyword indicated by the retrieval request in the retrieval result record area 42. The registration buffer index registration unit 221 sets the registration buffer index flag (refer to reference numeral 1003 of FIG. 2) corresponding to part coincident with the retrieval character of the text data in the registration text buffer 39 to “1” (step S705) and the processing proceeds to step S710. That is, the registration buffer index registration unit 221 stores in the registration text buffer 39 that the character in the text data of the registration text buffer 39 is coincident with the retrieval keyword designated by the retrieval request.

On the other hand, in step S701, when the text data gotten in step S700 does not satisfy the conditions designated by the retrieval request (“No” of step S701), the processing proceeds to step S730. The processing in step S730 is described later.

Next, the registration buffer index registration unit 221 judges whether the conditions designated by the retrieval request are already stored in the registration buffer index 40 or not (step S710). That is, the registration buffer index registration unit 221 judges whether the record concerning the character coincident with the retrieval keyword (e.g. “ [symbol] of [symbol] ) designated by the retrieval request is stored in the registration buffer index 40 or not. When the conditions designated by the retrieval request are already stored in the registration buffer index 40 (“Yes” of step S710), the registration buffer index registration unit 221 stores the record number and the character position of the text data as the same character link of the retrieval character coincident with (or satisfying) the conditions of the retrieval request in the registration buffer index 40. Moreover, the retrieval result judgment flag 41 is set to “1” (step S720).

For example, when the registration buffer index registration unit 221 detects the character of [symbol] ” at another character position from the same text data in case where the record concerning the retrieval character of [symbol] is already stored in the registration buffer index 40 illustrated in FIG. 3, the record number “001” and the character position “18” of the text data are stored as the same character link of the retrieval character of

[symbol]

On the other hand, when the conditions designated by the retrieval request are not stored in the registration buffer index 40 (“No” of step S710), the registration buffer index registration unit 221 stores the character coincident with the conditions and information (data number and character position) stored in the retrieval result record area 42 into the retrieval buffer index 40 (step S721).

Next, the registration buffer index registration unit 221 judges whether all the text data stored in the registration text buffer 39 are estimated for the conditions designated by the retrieval request or not (step S730). When all the text data stored in the registration text buffer 39 are estimated for the conditions designated by the retrieval request (“Yes” of step S730), the processing proceeds to step S740. On the other hand, when there is any text data not estimated (“No” of step S730), the processing is returned to step S700.

Next, the registration buffer index registration unit 221 judges whether the value of the retrieval result judgment flag 41 is “0” or not (step S740). When the value of the retrieval result judgment flag 41 is “0” (“Yes” of step S740), the registration buffer index registration unit 221 stores the data number of the data containing the character string designated by the retrieval request and the character position “−1” into the registration buffer index 40 (step S750). The registration buffer index retrieval unit 222 returns a report to the effect that the data of the registration text data 39 and the conditions (designated by retrieval request) are not coincident to the inquiry source (step S752). On other hand, when the value of the retrieval result judgment flag 41 is not “0” (“No” of step S740), the registration buffer index retrieval unit 222 returns a report (retrieval result) to the effect that the data of the registration text buffer 39 and the conditions designated by the retrieval request are coincident to the inquiry source (step S751) and the processing is ended.

As described above, the registration buffer index management unit 220 retrieves the registration text buffer 39.

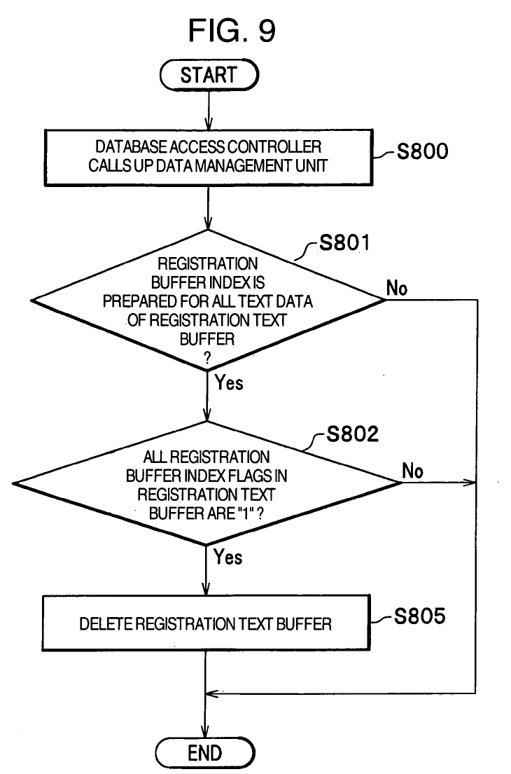

Referring now to FIG. 9, the processing procedure of the registration text buffer deletion unit 217 of FIG. 1 is described. FIG. 9 is a flow chart showing the processing procedure of the registration text buffer deletion unit of FIG. 1.

The database access controller 210 calls up the registration text buffer deletion unit 217 of the data management unit 216 (step S800). Next, the called-up registration text buffer deletion unit 217 judges whether the registration buffer index 40 are prepared for all the text data of the registration text buffer 39 or not (step S801). When the registration buffer index 40 has been prepared for all the text data of the registration text buffer 39 (“Yes” of step S801), the registration text buffer deletion unit 217 judges whether all the registration buffer index flags (indicated by reference numeral 1003 of FIG. 2) in the registration text buffer 39 are “1” or not (step S802). That is, the registration text buffer deletion unit 217 judges whether the text data stored in the registration text buffer 39 contains character having the registration buffer index 40 not prepared or not.

When all the registration buffer index flags in the registration text buffer 39 are “1” (“Yes” of step S802), the registration text buffer deletion unit 217 deletes the registration text buffer 39 (step S805) and the processing is ended.

On the other hand, when the text data of the registration text buffer 39 contains the registration buffer index 40 not prepared (“No” of step S801) or when the registration text buffer 39 contains the registration buffer index flag set to “0” (“No” of step S802), the registration text buffer 39 is not deleted and the processing is ended.

As described above, after the registration text buffer deletion unit 217 confirms that the registration buffer index 40 for all the text data and all the character strings in the registration text buffer 39 has been prepared, the registration text buffer deletion unit 217 can delete the registration text buffer 39. Moreover, since the registration text buffer 39 having the registration buffer index 40 prepared can be deleted from the main memory 203, the memory capacity of the main memory 203 can be utilized effectively. Since the database access controller 210 is not required to retrieve the registration text buffer 39, the retrieval time can be shortened.

The registration text buffer deletion unit 217 may delete only the text data having the prepared registration buffer index 40 from the text data in the registration text buffer 39 in the embodiment. That is, the registration text buffer deletion unit 217 may delete the text data in the registration text buffer 39 partly. For example, the registration text buffer deletion unit 217 deletes the text data having all the characters given the registration buffer index flags (refer to reference numeral 1003 of FIG. 2) set to “1” from the text data in the registration text buffer 39.

The index restore unit 214 reflects the registration buffer index 40 prepared in the above procedure in the index 63. The index restore unit 214 deletes the registration buffer index 40 reflected in the index 63. The deletion is performed, for example, at the timing that an amount of data of the index stored in the registration buffer index 40 exceeds a predetermined threshold. By doing so, the registration buffer index 40 is reflected in the index 63 when the index is stored in the registration buffer index 40 to some degree and accordingly the number of processing for reflection in the index 63 can be reduced.

In addition to the above example, it is considered as the timing of reflection in the index 63 (1) when the retrieval request is received from an external device, (2) when the retrieval request containing the predetermined conditions is received from the external device, (3) when the data amount or the number of indexes stored in the registration buffer index 40 exceeds a threshold, (4) when an index is registered in the registration buffer index 40, (5) when the occupancy rate of the CPU 202 is reduced to a threshold or less, (6) when the retrieval performance of the database access controller 210 is reduced to a threshold or less, (7) when the present situation reaches the situation similar to the reflection timing of the index 63 in the past, (8) when a previously set reflection time is reached, (9) when a predetermined time elapses after the last reflection in the index 63, and (10) when the remaining amount of data storable in the registration buffer index 40 is reduced.

Furthermore, the index restore unit 214 may reflect part of the registration buffer index 40 in the index 63 instead of reflecting all the registration buffer index 40 in the index 63. At this time, the index restore unit 214 may preferentially select the index having long waiting time for reflection from the index in the registration buffer index 40 or may select the index at random. Moreover, the number of indexes in the registration buffer index 40 reflected in the index 63 may be changed depending on a time zone.

The parameter used to make the index restore unit 214 reflect the registration buffer index 40 in the index 63 as described above is stored in a predetermined area of the main memory 203.

In the above embodiment, the numbers of grams for the registration buffer index 40 and the index 63 may be the same number of grams (e.g. 1-gram). By doing so, the index restore unit 214 can reduce the processing load at the time of reflecting the registration buffer index 40 in the index 63.

Moreover, in the retrieval processing of the above embodiment, characters are retrieved by way of example, although marks or symbols may be retrieved.

It should be further understood by those skilled in the art that although the foregoing description has been made on embodiments of the invention, the invention is not limited thereto and various changes and modifications may be made without departing from the spirit of the invention and the scope of the appended claims.

1. A data registration and retrieval method in a database system including a memory in which a registration data buffer for storing data unreflected in a database and an index for retrieving data reflected in the database are stored and for retrieving data of an object for a retrieval request using the index and the registration data buffer in the memory when the retrieval request of data is received, comprising:
preparing a registration buffer index for performing retrieval for data in the registration data buffer and storing the prepared registration buffer index in the memory when a retrieval request of data is received and data of an object for the received retrieval request is stored in the registration data buffer; and
retrieving data of the object for the retrieval request using the index, the registration buffer index and the registration data buffer in the memory in response to receiving of the retrieval request of data.

2. A data registration and retrieval method according to claim 1, wherein
the database system deletes data having the registration buffer index prepared for character constituting the data in the registration data buffer from the registration data buffer.

3. A data registration and retrieval method according to claim 2, wherein
the database system reflects the registration buffer index in the index and deletes the registration buffer index reflected in the index from the memory.

4. A data registration and retrieval method according to claim 3, wherein
the database system reflects the registration buffer index in the index when a predetermined amount of registration buffer index is stored in the memory.

5. A data registration and retrieval method according to claim 1, wherein
the database system prepares an index having the same gram number as the index when the registration buffer index is prepared.

6. A data registration and retrieval method according to claim 2, wherein
the database system
judges whether data in the registration data buffer of a preparation source for the registration buffer index contains retrieval keyword indicated by the retrieval request for each of the data or not when the registration buffer index is prepared,
gives a predetermined flag value to part containing the retrieval keyword of the data when the data contains the retrieval keyword indicated by the retrieval request, and
deletes the data from the registration data buffer when the predetermined flag value is given to all parts of the data.

7. A data registration and retrieval program making a computer perform the data registration and retrieval method according to claim 1.

8. A data registration and retrieval program making a computer perform the data registration and retrieval method according to claim 2.

9. A data registration and retrieval program making a computer perform the data registration and retrieval method according to claim 3.

10. A data registration and retrieval program making a computer perform the data registration and retrieval method according to claim 4.

11. A data registration and retrieval program making a computer perform the data registration and retrieval method according to claim 5.

12. A data registration and retrieval program making a computer perform the data registration and retrieval method according to claim 6.

13. A database system comprising:
a memory in which a registration data buffer for storing data unreflected in a database and the index for retrieving data reflected in the database are stored; and
a database access controller to prepare a registration buffer index for performing retrieval for data in a registration data buffer and storing the prepared registration buffer index in the memory when a retrieval request of data is received and data of an object for the received retrieval request is stored in the registration data buffer and, when the retrieval request of data is received, to retrieve data of the object for the retrieval request using the index and retrieve data of the object for the retrieval request using the registration buffer index and the registration data buffer.
